(19) United States
(12) Patent Application Publication
(10) Pub. No.: US 2007/0272063 A1
(43) Pub. Date: Nov. 29, 2007

(54) Device And Method For Machining Long Workpieces Fixed Between Two Rotating Bearings

(76) Inventor: Pasquale Angione, Castres (FR)

Correspondence Address: JEROME D. JACKSON (JACKSON PATENT LAW OFFICE), 211 N. UNION STREET, SUITE 100, ALEXANDRIA, VA, 22314, US

(21) Appl. No.: 10/599,382

(22) PCT Filed: Mar. 25, 2005
(86) PCT No.: PCT/FR05/50194

§ 371 Date: Sep. 27, 2006

(30) Foreign Application Priority Data
Mar. 29, 2004 (FR) 0403259

(51) Int. Cl. B23B 11/00

(52) U.S. Cl. 82/117; 29/27 R; 409/165; 82/120; 82/142

(57) ABSTRACT

The invention relates to a machining device (D) such as a device associating a machine-tool (100) with a workpiece holding device (200) having an axis about which the workpiece is rotated transversally (A) in relation to the downward axis (Z), the workpiece to be machined (300) being a long workpiece such as a workpiece comprising surfaces to be machined that are concentrated at the two ends thereof. Said machining device is characterised in that the workpiece holding device (200) consists of a frame (210) supporting two guiding bearings (210 and 230) for rotatably guiding the workpiece according to the transversal rotation axis (A), the structure formed by the frame (210) and the two bearings (220 and 230) being closed by the workpiece to be machined (300) by fixing the ends of the workpiece to the bearings (310 and 220). The invention also relates to a method for machining long workpieces.

### FIELD OF THE INVENTION

The present invention relates to the field of high-speed machining of elongated workpieces such as those used in automobile transmission and notably to the adaptations allowing improvement of the quality and duration of such machinings.

### DESCRIPTION OF THE PRIOR ART

Elongated workpieces of the type used in automobile transmission, such as a frame rear cross member or a motor cradle, necessitate the carrying out of machinings requiring a machine-tool offering a tool with five axes of movement. These workpieces have furthermore the characteristic of presenting machinable zones essentially on their ends.

Up to present, manufacturing method designers developed two machining solutions to ensure the manufacturing of this type of workpiece.

A first solution includes carrying out the required machinings by a transfer type machine composed of a succession of machine-tools respectively dedicated to a type of machining. This solution although rapid has a disadvantage of being not very flexible, requiring the presence of specialized machines.

Another solution includes carrying out the required machinings by a machine capable of working on at least five axes. Such a solution has a disadvantage of conventionally using a machine-tool possessing these five axes often with parallel architecture and of which the power of the spindle is not particularly elevated thus augmenting the duration of the machining. The duration of the machining is longer to the extent that the spindle of the machine-tool is forced to successively machine the two ends. Furthermore, the precision of the machining tied to the repeatability and to the precision of the positioning of the spindle can be improved.

Several constraints were preventing up to present manufacturing method designers from carrying out most of the machinings by a flexible machining center actuating on three axes a machine-tool-holding slide, among them:

the accessibility of the set of faces of the workpiece, conventionally of the number four, and of which the surfaces to be machined are presented essentially on two opposite faces of this type of workpiece, the attachment of this workpiece on a workpiece-holding device obstructing the accessibility of one of the faces,

the length of the workpieces that, in order to convey the surfaces to be machined to the reach of the tool or vice-versa, necessitate either a displacement of the workpiece generator of imprecision, or a travel length of the tool that few machine-tools are capable of offering,

etc . . .

There exist furthermore other machining centers such as those described below.

The German document number DE 201 18 456 U describes a machine-tool, including

a frame

a horizontal guiding track that defines an X axis,

two apparatus supports or two apparatus support sections,

two spindles having a horizontal parallel axis, that are respectively mobile on the apparatus supports and independent from each other according to a Y axis and a Z axis,

a turning plate transport mobile on the guide track,

at least a turning plate that is arranged pivoting around a horizontal point of support with respect to the turning plate transport and guides at least an attachment means for a workpiece to be worked.

Thus, the workpiece to be machined is attached on a machining mounting. It is in fact put and maintained in position on a turntable at least according to a horizontal axis. The presence of this table obstructs the access for the tools to the set of faces of the workpiece. The presence of a machining mounting leads furthermore to a larger mass and requires a guiding of the turntable at its two ends.

This document therefore does not offer a particular design of the actuation module for a long workpiece, but simply an actuation means for a turning plate on which is installed the machining mounting supporting the workpiece. Consequently, the bearings for rotational guidance according to a horizontal axis each assure the rotation of a plate, these plates being coupled between themselves by the plate supporting the machining mounting. Also, the two turning plates are already coupled between themselves by a coupling element other than the workpiece.

This type of bi-spindle machine-tool conventionally has a utility either of machining a single workpiece eliminating the changing time of the tool, or machining two workpieces simultaneously.

The characteristic of a workpiece concentrating surfaces to be machined at its ends leads to, for a monospindle machine-tool, a relative displacement in the direction of the length of the workpiece between the tool and the workpiece in order to make the set of zones to be machined accessible. For a machine-tool, such as described in this document, it also leads to a displacement of the workpiece since the tools are not mobile in X.

The German document number DE 203 04 653 U describes a machining station including at least a machining unit more particularly a tool-holding spindle for the machining of the workpiece. The object is approached at a point of discharge and there taken by a workpiece trolley. The workpiece trolley displaces the workpiece for a machining to the machining unit or displaces the object during its machining by the machining unit.

As illustrated and as described the object trolley is constituted by a support plate turning according to a horizontal axis and rotationally guided at its two ends by two bearings. Thus, the workpiece is supported during its machining phase by a support plate assuring the coupling between two guiding bearings.

The German document number DE 101 19 175 A describes a machine-tool that can have two work spindles arranged in a horizontally suspended manner. The work spindles are mounted in the spindle axes installed mobile on a sliding trolley on the frame. The offered workpiece-holding devices do not allow contemplation of an efficient suspension of the workpiece. In fact, either the workpiece is put on the turning plate, or it is suspended from a plate by one of its ends/faces.

### DESCRIPTION OF THE INVENTION

Given this situation, the applicant conducted research studies having the objective of offering a machining solution capable of using means remaining flexible and offering an elevated machining pace. The applicant therefore searched to find an alternative to the different solutions of the prior art that were each presenting specific disadvantages.

These research studies have resulted in the conception and the realization of a machining device and method bringing into play original means for machining and means for holding the workpiece.

According to the invention, the machining device such as a device associating a machining machine-tool with a workpiece-holding device having an actuation axis of transverse rotation with respect to the downward axis. This device is characterized by the fact that the workpiece-holding device is constituted by a frame supporting two bearings for rotationally guiding according to the aforementioned transverse rotation axis, the structure formed by the frame and the two bearings being closed by the workpiece to be machined, the ends of which being fixed to the aforementioned bearings, the workpiece to be machined being a long workpiece such as a workpiece including surfaces to be machined concentrated at its two ends and in that the machine-tool is of the type assuring the actuation of the two independent workpiece-holding slides in a manner in which the machinings of the two ends of the workpiece are carried out by a different slide.

This feature resolves the problem of accessibility in that it avoids the presence of a transverse plate supporting the workpiece and coupling the two bearings. This absence allows the tool of the machine-tool, to which is associated the workpiece-holding device, to machine the set of faces of the long workpiece.

The separation of the two bearings of the workpiece-holding device is adapted to the length of the long workpiece. The absence of a transverse plate made possible by the length of the workpiece constitutes a particularly innovative technical choice compared to that which is generally conventionally designed in the workpiece-holding devices that all offer, based on the point where the workpiece is not a turning workpiece, a support plate of the workpiece.

This absence of a plate in the device of the invention improves the accessibility for the machinings that must be realized at the ends of the workpiece and that are, in the mounting offered by the invention, the parts closest to the bearings. Thus, the parts of the workpiece most subject to the stresses of the machinings are those that are the closest to the rigid parts of the workpiece-holding device.

The feature tied to the utilization of slides, that is to the modules each conventionally assuring the support and the actuation of an electrode-spindle tool holder, resolves the travel problem due to the length of the workpiece and the separation of its parts to be machined.

Furthermore, the feature including using a machine-tool having two slides or tool-holding spindles both capable to move on three axis and independently one from the other is particularly important in that it allows carrying out of simultaneous asymmetric machinings with respect to the principal axes of the workpiece.

The association of these two features allows resolution of the disadvantages of the prior art by offering a machining device capable of simultaneously carrying out most of the machining operations of the two ends and of the faces of the workpiece from a common mounting and without displacing the workpiece. The simultaneous machinings of the two ends allows halving the machining time of the workpiece, resolving one of the problems of the prior art.

It was in fact known that the possible applications of a bi-spindle machine-tool were being up to present the following:

working on a common workpiece by alternating of the slides, the changing of the tools being carried out in it in masked time,

working on two often identical workpieces by the two slides separately.

The bi-spindle configuration had not been therefore ever considered for the carrying out of a simultaneous machining with two slides on a common workpiece. It is the length of the workpiece (creating the necessary separation) and the fact that the surfaces to be machined are located concentrated at its ends (avoiding excessively large travels in X) that allow the separate simultaneous and independent machinings by the two slides.

Another object of the invention is constituted by the machining method for a long workpiece such as a workpiece including surfaces to be machined concentrated at its two ends. In accordance with the invention, the machining method is characterized in that it includes carrying out the machining operations requiring up to four axes of movement by the means of a machine-tool assuring the actuation of two independent tool-holding slides in a manner in which that the machinings of the two ends are carried out simultaneously by a different slide, and subsequently carrying out the machining operations requiring a larger number of axes of movement by means of a special machine.

This feature is particularly advantageous in that the method exploits first a machining center capable of realizing machinings other than those intended for the type of particular workpieces that are long transmission workpieces. Thus, the manufacture of such workpieces can be integrated with a flexible machining line. Furthermore, in carrying out simultaneously the machinings of the two ends by means of the implementation of the two independent slides, this machining method offers high speed despite the transfer time of the workpiece to another machine-tool dedicated to the special machinings. This reduction of the machining time reduces the investment necessary for the installation of a manufacturing line for of such workpieces. This method constitutes therefore the result of a selection of means of manufacture allowing, in the framework of an application to the long workpieces, the offering of an original chaining of operations obviating disadvantages of the prior art.

In the prior art, the characteristics of the long workpiece to be machined had led to the following solutions:

that a special multi-axis machine-tool be used to realize the ensemble of the machinings or

that a succession of mono-axis machines be used to each realize a particular machining.

The long workpiece, its device for driving and maintaining in position and its machining device allowed contemplation of another cycle of realization by carrying out the machinings necessitating up to four machining axes (X, Y, Z with the rotation in the A axis of the workpiece) on the bi-spindle machine-tool, and subsequently the carrying out of machinings necessitating other axes on a special multi-axis machine-tool.

According to another feature of the invention, the method is characterized in that it includes turning over the workpiece according to its longitudinal axis during the machining operations in the machine-tool implementing two independent slides. This feature allows providing access to the ensemble of machining surfaces to the tools from the same machine mounting, which the workpiece-holding devices of the prior art, of which the turning support table obstructs the access, do not allow.

The fundamental concepts of the invention have just been explained above in their most elementary form. Other details and features will reemerge more clearly at the reading of the description that follows and corresponds to the annexed drawings giving, by way of non-limiting example, an implementation mode of a device in accordance with the invention.

### BRIEF DESCRIPTION OF THE DRAWINGS

FIG. 1 is a schematic drawing of a perspective view of an implementation mode of the machining device according to the invention, in which a workpiece to the machined has been installed in schematic fashion

FIG. 2 is a schematic drawing of a perspective view of a long workpiece intentionally simplified to illustrate its principle of attachment to the workpiece-holding device.

### DESCRIPTION OF THE PREFERRED IMPLEMENTATION MODES

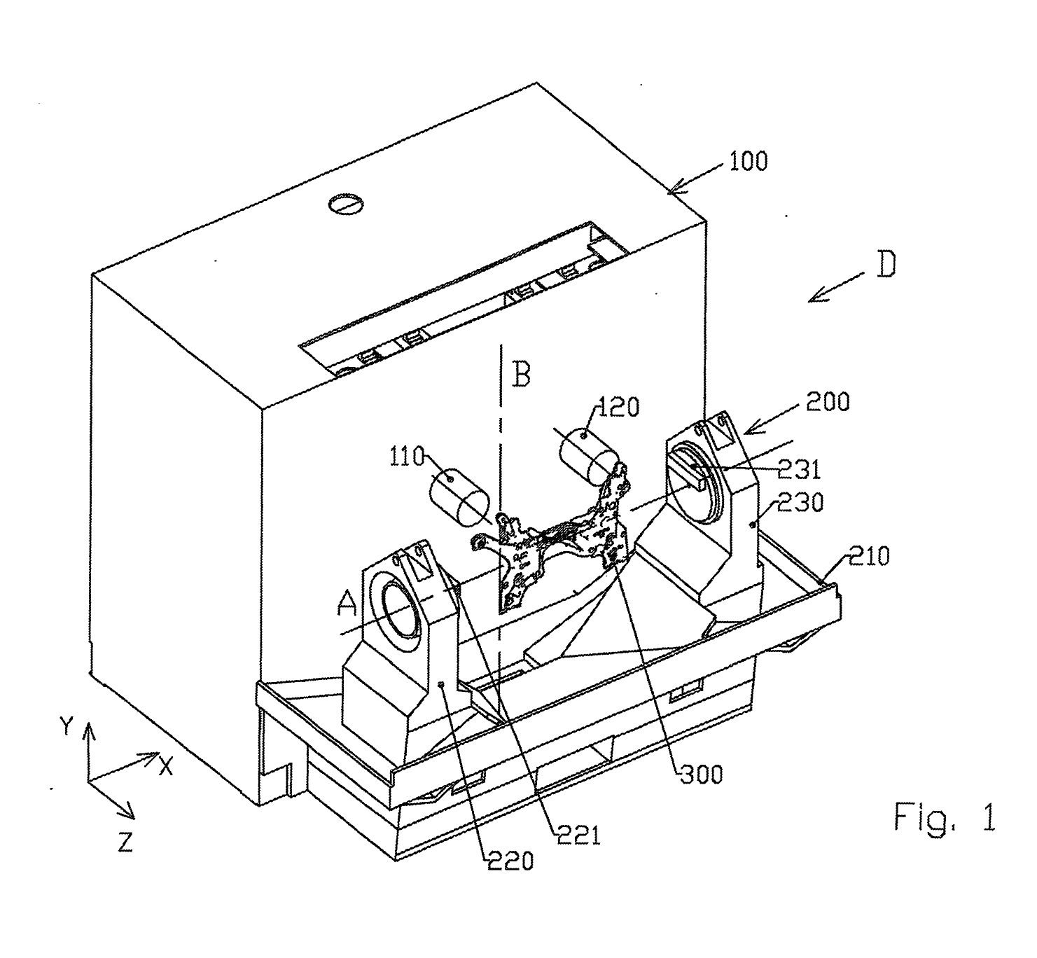

As illustrated on the drawing of FIG. 1, the machining device referred to as D in its entirety includes a machine-tool 100 and a workpiece-holding device 200 in the interior of which is represented a workpiece 300.

As illustrated, the machine-tool 100 is a machining machine-tool having very high speed actuating according to three axes X, Y and Z and independently one from the other, two slides 110 and 120 supporting the tool-holding electro-spindles not illustrated.

According to a technical choice allowing optimization of the precision and the speed of the machining operation, the illustrated machine-tool is of the type that includes a plurality of guiding means corresponding to the rectilinear movements of the two slides according to three axes where the guiding means are constituted by pairs of guiding rails, and that implements the aforementioned independent movements by linear motors.

While the length of the workpiece does not allow a good exploitation of a machine-tool actuating a single slide according to three axes due to the length separating the two ends to be machined, a bi-spindle machine-tool constitutes the ideal capability for the carrying out of the machining of these workpieces. In fact, in implementing two slides, the two ends of the workpiece can be machined simultaneously without displacing the workpiece to convey it from a first slide to the other.

Furthermore, the separation of the zones to be machined constitutes, for a bi-spindle configuration, an advantage in that it is not necessary to carry out long travels for each slide to access the zones to be machined which contributes to a better precision of the machinings carried out by each spindle.

To implement this capability, an original workpiece-holding device is coupled to this bi-spindle machine-tool 100. In accordance with the invention, the workpiece-holding device 200 is constituted by a frame 210 supporting two bearings 220 and 230 for guiding in rotation according to a horizontal rotation axis traverse to the downward axes Z of the two slides, the structure formed by the frame 210 and the two bearings 220 and 230 being closed by the workpiece to be machined 300. The closing of the structure of the workpiece-holding device 200 by the workpiece 300 itself has at least two advantages. In fact, on the one hand it contributes to better distribution of the stresses to which the device 200 is submitted during the machining and on the other hand allows the absence of a mobile coupling element between the two bearings 220 and 230. As explained above, this absence has for advantages not only to allow access to the entire workpiece when the latter is turned over according to the machining process but also to avoid the actuation of a plate or of a workpiece-holding mounting.

As illustrated on the drawing of FIG. 1, each bearing 220 and 230 includes and guides a turning plate 221 and 231 having a motorized actuation means, the rotation of the two plates 221 and 231 being synchronized by control and a means for placing in position and maintaining in position. The choice of a motorization at the two ends of the workpiece has an advantage of avoiding that an end can be shifted with respect to the other, either when in movement or in fixed position. The synchronization of the motor means of each bearing guarantees an optimized positioning and maintenance in position for the workpiece.

According to a preferred implementation mode, each bearing includes a direct drive motor of which the control is synchronized.

The placement in position as well as the maintenance in position of the workpiece in the workpiece-holding device of the invention has been optimized despite the absence of a transverse horizontal workpiece-holding plate.

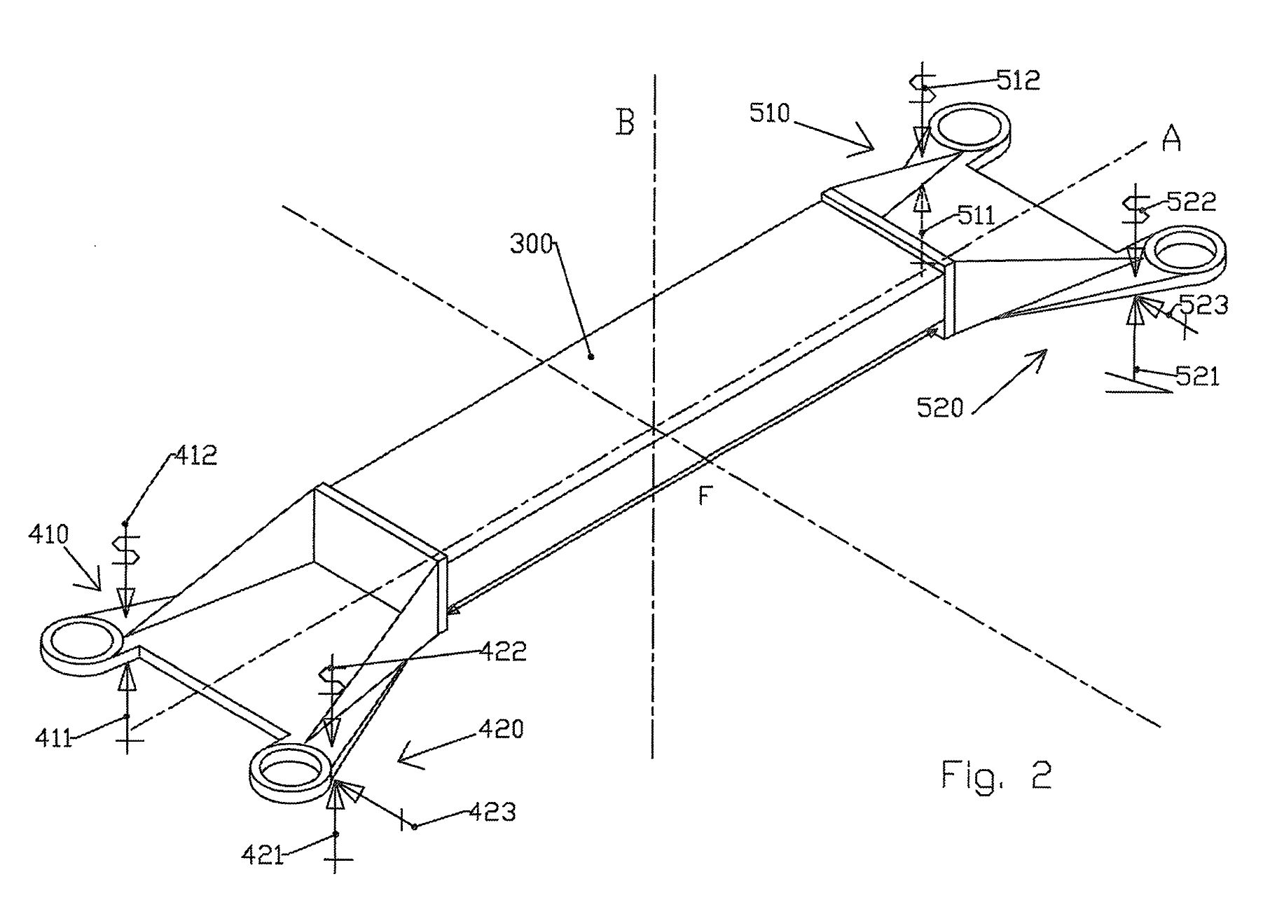

As illustrated on the drawing of FIG. 2, the device is characterized in that each motorized plate 231 and 221 has two supports 410, 420 and 510, 520 for receiving and maintaining in position, the end of the workpiece 300. According to the illustrated implementation mode and according to the invention, the workpiece 300 adopts a general elongated and flattened shape constituted by two principal faces with two opposite ends at the end of which the surfaces to be machined are concentrated.

These supports are schematically represented by associations of arrows representing the elements constituting these supports.

As illustrated, each support 410, 420, 510, 520 is at least constituted by a lower support 411, 421, 511, 521 in opposition to which acts a gripping means 412, 422, 512, 522.

On two of the supports, namely the supports 420 and 520, the lower support and the upper gripper are coupled to a third element for positioning 423 and 523 from a direction perpendicular to that of the lower supports and assuring the piling of the workpiece 300 onto the supports.

According to a preferred implementation mode, a 520 of the supports of one of the plates is constituted by a retightened support. Thus, the workpiece 300 is installed on four supports but as the plane of support is defined by three points, the applicant advantageously conceived a fourth support 520 adapting itself to the position taken by the workpiece 320 on the three other supports 410, 420, 510 avoiding any deformation of the workpiece during the maintenance in position. This adaptation is embodied by the utilization of a lower support 521 having adjustable position. This association of three static supports with a retightened support guarantees a good holding of the workpiece despite the absence of a mobile traverse workpiece-holding plate.

The drawing of FIG. 2 also illustrates, by the double beam F, a phase of the machining method, for long workpieces, of the invention that includes, before the machining operation, making contacts by a sensor, or equivalent device, on the workpiece 300 on surfaces designed to be symmetric in order to determine the plane of symmetry of the long workpiece 300 so that it can serve as a reference when carrying out the machinings.

According to another feature of the invention, the frame 210 of the workpiece-holding device 200 is itself mounted mobile in rotation according to an axis B perpendicular to the rotation axis A defined by the two bearings 220 and 230 that it supports. This feature provides a supplemental actuation axis to the workpiece, thus augmenting the range of the machinings possible to carry out by means of this machining device D.

One understands that the device and machining method, that has just been described and represented above, were made in view of a disclosure rather than a limitation. Of course, various accommodations, modifications and improvements can be applied to the example above, without departing from the framework of the invention.

1. A machining device (D) such as a device associating a machining machine-tool (100) with a workpiece-holding device (200) having an actuation axis (A) of transverse rotation with respect to the downward axis (Z), CHARACTERIZED BY THE FACT THAT the workpiece-holding device (200) is constituted by a frame (210) supporting two bearings (210 and 230) for rotationally guiding according to the aforementioned transverse rotation axis (A), the structure formed by the frame (210) and the two bearings (220 and 230) being closed by the workpiece to be machined (300), the ends of which being fixed to the aforementioned bearings (310 and 220), the workpiece to be machined (300) being a long workpiece such as a workpiece including surfaces to be machined concentrated at its two ends AND BY THE FACT THAT the machine-tool (100) is of the type assuring the actuation of the two independent workpiece-holding slides (110 and 120) in a manner in which the machinings of the two ends of the workpiece (300) are carried out by a different slide.

2. A machining device (D) according to claim 1, CHARACTERIZED BY THE FACT THAT each bearing (220 and 230) includes and guides a rotating plate (221 and 231) having a motorized actuation means, the rotation of the two plates (221 and 231) being synchronized.

3. A machining device (D) according to claim 2, CHARACTERIZED BY THE FACT THAT each plate (220 and 230) has two supports (410, 420 and 510, 520) for receiving and maintaining in position the end of the workpiece (300).

4. A machining device (D) according to claim 1, CHARACTERIZED BY THE FACT THAT the frame (210) of the workpiece-holding device (200) is itself mounted mobile in rotation according to an axis (B) perpendicular to the axis (A) of rotation defined by the two bearings (220 and 230) that it supports.

5. A machining method for a long workpiece (300) such as a workpiece including surfaces to be machined concentrated at its two ends CHARACTERIZED IN THAT it includes carrying out the machining operations requiring up to four axes of movement by the means of a machine-tool (100) assuring the actuation of two independent tool-holding slides (110 and 120) in a manner in which that the machinings of the two ends are carried out simultaneously and by a different slide, and subsequently carrying out the machining operations requiring a larger number of axes of movement by means of a special machine.

6. A method according to claim 5, CHARACTERIZED IN THAT it includes turning over the workpiece (300) according to its longitudinal axis (A) during the machining operations in the machine-tool (100) implementing two independent slides (110 and 120).

7. A method according to claim 5, CHARACTERIZED IN THAT it includes, before the machining operation, making contacts by a sensor, or equivalent device, on the workpiece (300) on surfaces designed to be symmetric in order to determine the plane of symmetry of the long workpiece (300) so that it can serve as a reference when carrying out the machinings.
